(19) United States
(12) Patent Application Publication
(10) Pub. No.: US 2023/0240366 A1
(43) Pub. Date: Aug. 3, 2023

(54) HEATER AND SMOKING SET INCLUDING SAME

(71) Applicant: SHENZHEN FIRST UNION TECHNOLOGY CO., LTD., Shenzhen, Guangdong (CN)

(72) Inventors: JIAMAO LUO, Shenzhen City, Guangdong Province (CN); BAOLING LEI, Shenzhen City, Guangdong Province (CN); JIAN WU, Shenzhen City, Guangdong Province (CN); ZUQIANG QI, Shenzhen City, Guangdong Province (CN); FUWEN LIN, Shenzhen City, Guangdong Province (CN); ZHONGLI XU, Shenzhen City, Guangdong Province (CN); YONGHAI LI, Shenzhen City, Guangdong Province (CN)

(21) Appl. No.: 17/918,896

(22) PCT Filed: Apr. 13, 2021
(86) PCT No.: PCT/CN2021/086819

§ 371 Date: Oct. 13, 2022

(30) Foreign Application Priority Data
Apr. 13, 2020 (CN) 202010284562.9

(51) Int. Cl. A24F 40/46; A24F 40/70

(52) U.S. Cl. CPC A24F 40/46; A24F 40/70; A24F 40/57

(57) ABSTRACT

A heater includes a metal base, having an inner surface and an outer surface; an oxide film, formed by oxidization on the inner surface of the metal base, the oxide film being configured to generate infrared rays and at least radiatively heat an aerosol generation substrate; and a heating body, provided on the outer surface of the metal base, the heating body being configured to receive electric power from a power supply to generate heat, and transfer the heat to the oxide film such that the oxide film is heated by the heat and the temperature thereof rises, to generate infrared rays. According to the present application, the heating body is adopted to heat the oxide film formed by oxidization on the surface of the metal base, such that the oxide film generates infrared rays to radiatively heat the aerosol generation substrate.

### CROSS-REFERENCE TO RELATED APPLICATIONS

The present application claims priority to the Chinese Patent Application No. 202010284562.9, filed on Apr. 13, 2020 and entitled “HEATER AND SMOKING SET INCLUDING SAME”, which is incorporated herein by reference in its entirety.

### TECHNICAL FIELD

The present application relates to the technical field of heat-not-burn smoking sets, and in particular relates to a heater and a smoking set including the same.

### BACKGROUND

Smoking articles (such as cigarettes, cigars, etc.) burn tobacco during use to produce smoke. Attempts have been made to provide alternatives to these articles that burn tobacco by making products that release compounds without burning. Examples of such products are so-called heat-not-burn products, which release compounds by heating tobacco, rather than burning tobacco.

An existing low-temperature heat-not-burn smoking set mainly generates heat by a heating body, and conducts the heat by a conductor to an aerosol generation substrate material containing tobacco placed in a cavity, enabling at least one component to volatilize to generate an aerosol for smoking by a user. This heating mode is fast in temperature rise, but has the problems that the heat conduction efficiency is low, preheating of the aerosol generation substrate is slow, and the interior of the substrate material is difficult to effectively heat, resulting in that the aerosol is poor in taste and poor in experience. In addition, a low-temperature heat-not-burn smoking set is further provided, where an outer surface of a base is coated with a far-infrared electric heating coating and a conductive coating, and after being electrified, the far-infrared electric heating coating is heated to emit far-infrared rays to penetrate through the base and heat an aerosol generation substrate material on the inner side of the base. The far-infrared rays have high penetrability, and can penetrate through the periphery of the aerosol generation substrate to enter the interior, such that the heating of the aerosol generation substrate is relatively uniform. However, a semiconductor material needs to be selected for the far-infrared electric heating coating in this manner, which is small in selection range, generally large in resistance, low in heat efficiency and slow in temperature rise rate, and thus causes the problems of slow preheating speed and poor user experience.

The main problem of the above structure is that the preheating time of the aerosol generation substrate is long, and the user experience needs to be improved.

### SUMMARY

The present application provides a heater and a smoking set including the same, and aims to solve the problem that the existing smoking set is long in preheating time.

A first aspect of the present application provides a heater, configured to heat an aerosol generation substrate to volatilize at least one component in the aerosol generation substrate, including:

a metal base, having an inner surface and an outer surface;

an oxide film, formed by oxidization on the inner surface of the metal base, the oxide film being configured to generate infrared rays and at least radiatively heat the aerosol generation substrate; and

a heating body, provided on the outer surface of the metal base, the heating body being configured to receive electric power from a power supply to generate heat, and transfer the heat to the oxide film such that the oxide film is heated by the heat and the temperature thereof rises, to generate infrared rays.

A second aspect of the present application provides a smoking set, including a housing assembly and the heater according to the first aspect, the heater being provided within the housing assembly.

According to the heater and the smoking set including the same provided by the present application, the heating body is adopted to heat the oxide film formed by oxidization on the surface of the metal base, such that the oxide film generates infrared radiation to heat the aerosol generation substrate. Therefore, a preheating time of the aerosol generation substrate is reduced, and the user experience is improved.

### BRIEF DESCRIPTION OF DRAWINGS

One or more embodiments are illustrated by pictures in the corresponding accompanying drawings, which are not intended to limit the embodiments, in which elements having the same reference numerals represent similar elements, and the figures of the accompanying drawings are not intended to constitute a scale limitation unless specifically stated otherwise.

FIG. 1 is a schematic diagram of a heater according to a first embodiment of the present application;

FIG. 2 is another schematic diagram of a heater according to the first embodiment of the present application;

FIG. 3 is a schematic diagram of a cross section of a heater having a spiral resistive heating tape according to the first embodiment of the present application;

FIG. 4 is another schematic diagram of a cross section of a heater having a spiral resistive heating tape according to the first embodiment of the present application;

FIG. 5 is a schematic diagram of a heater having a resistive heating layer wrapped on an outer surface of a metal base according to the first embodiment of the present application;

FIG. 6 is a schematic diagram of a heater having a heating element separable from a metal base according to the first embodiment of the present application;

FIG. 7 is a schematic diagram of a smoking set according to a second embodiment of the present application; and

FIG. 8 is an exploded schematic diagram of a smoking set according to the second embodiment of the present application.

### DETAILED DESCRIPTION

To facilitate the understanding of the present application, the present application will be described in more detail below with reference to the accompanying drawings and specific embodiments. It should be noted that when an element is referred to as being “fixed to” another element, it can be directly on the other element or one or more intervening elements may be present therebetween. When an element is referred to as being “connected” to another element, it can be directly connected to the other element or one or more intervening elements may be present therebetween. As used herein, the terms “upper,” “lower,” “left,” “right,” “inner,” “outer,” and the like are for illustrative purposes only.

Unless defined otherwise, all technical and scientific terms used herein have the same meaning as commonly understood by those of ordinary skill in the technical field to which this application belongs. The terms used in the specification of the present application is for the purpose of describing specific embodiments only and is not used to limit the present application. As used herein, the term “and/or” includes any and all combinations of one or more of associated listed items.

### First Embodiment

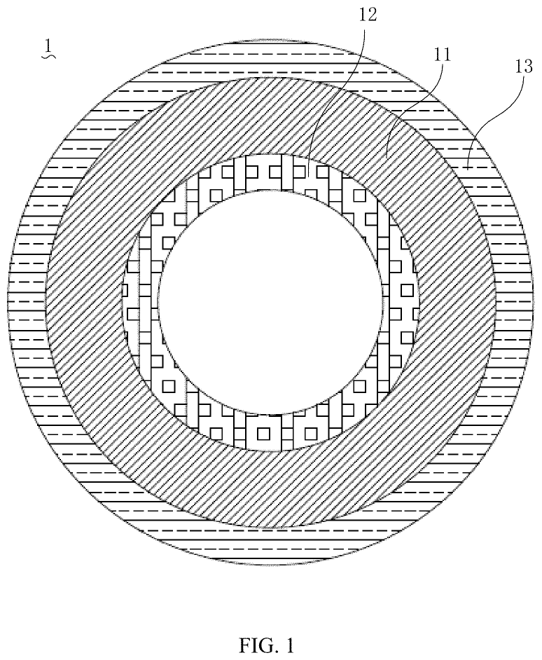

As shown in FIG. 1, the first embodiment of the present application provides a heater, configured to heat an aerosol generation substrate to volatilize at least one component in the aerosol generation substrate. The heater 1 includes a metal base 11, an oxide film 12 and a heating body 13.

The metal base 11 is provided with a space for accommodating the aerosol generation substrate, and an inner surface of the metal base 11 forms at least a part of the boundary of the space.

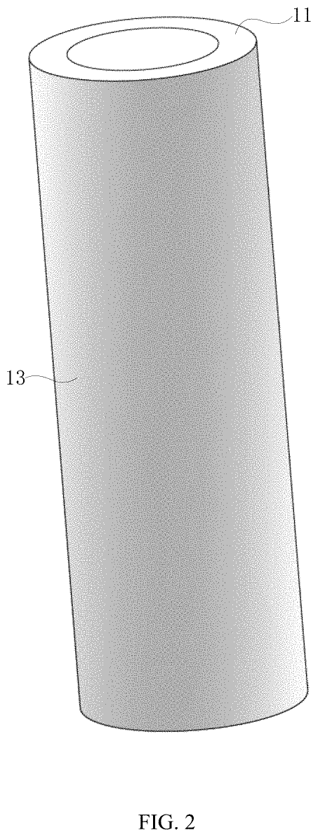

Referring to FIG. 2 for understanding, the metal base 11 has a first end and a second end opposite to each other, and the metal base 11 extends longitudinally between the first end and the second end and has an hollow interior provided with a cavity suitable for accommodating the aerosol generation substrate. The metal base 11 may be cylindrical, prismatic or another columnar shape. The metal base 11 is preferably cylindrical. The cavity is a cylindrical hole penetrating through the middle of the metal base 11, and the inner diameter of the hole is slightly greater than the outer diameter of a smoking product, such that the smoking product can be conveniently placed in the cavity for heating.

The aerosol generation substrate is a substrate capable of releasing volatile compounds that can form an aerosol. Such volatile compounds can be released by heating the aerosol generation substrate. The aerosol generation substrate may be solid or liquid or include solid and liquid components. The aerosol generation substrate can be loaded onto a carrier or support by means of adsorbing, coating, impregnating, or the like. The aerosol generation substrate may conveniently be a part of the smoking product.

The aerosol generation substrate may include nicotine. The aerosol generation substrate may include tobacco, e.g., may include a tobacco-containing material containing volatile tobacco flavor compounds that are released from the aerosol generation substrate when heated. Preferably, the aerosol generation substrate may include a homogenized tobacco material, e.g., deciduous tobacco. The aerosol generation substrate may include at least one aerosol generation agent, which may be any suitable known compound or mixture thereof. When in use, the compounds or mixtures thereof facilitate stable formation of the aerosol, and are substantially resistant to thermal degradation at an operating temperature of an aerosol generation system. Suitable aerosol generation agents are well known in the art and include, but are not limited to: polyols, such as triethylene glycol, 1,3-butanediol and glycerol; esters of polyols, such as glycerol monoacetate, glycerol diacetate and glycerol triacetate; and fatty acid esters of monocarboxylic acid, dicarboxylic acid or polycarboxylic acid, such as dimethyldodecanedioate and dimethyltetradecanedioate. Preferably, the aerosol generation agent is polyhydric alcohol or a mixture thereof, such as triethylene glycol, 1,3-butanediol and most preferably glycerol.

The oxide film 12 is generated by oxidization on the surface of the metal base 11. The oxide film 12 may be generated by oxidization on the outer surface of the metal base 11, or may be generated by oxidization on the inner surface of the metal base 11. Preferably, the oxide film 12 is generated by oxidization on the inner surface of the metal base 11.

The oxide film 12 is configured to generate infrared rays to at least radiatively heat the aerosol generation substrate. After the oxide film absorbs heat and the temperature thereof rises, the oxide film 12 can generate infrared rays of a certain wavelength, e.g., far infrared rays of 8 μm-15 μm. When the wavelength of the infrared rays is matched with an absorption wavelength of the aerosol generation substrate, the energy of the infrared rays is easy to be absorbed by the aerosol generation substrate. In this example, limitation is not made to the wavelength of the infrared rays, which may be infrared rays of 0.75 μm-1000 μm, preferably far-infrared rays of 1.5 μm-400 μm.

In the present example, the metal base 11 may be made of at least one of the following materials:

titanium, aluminum, zirconium, nickel, zinc, magnesium, tin, iron, chromium, indium, lanthanum, cobalt, antimony, manganese, cerium, copper, calcium, molybdenum, and alloys thereof.

Based on the above materials, oxides that can be generated by oxidation on the inner surface of the metal base 11 include but are not limited to: iron trioxide, aluminum oxide, chromic oxide, indium trioxide, lanthanum trioxide, cobaltic oxide, nickelic trioxide, antimony trioxide, antimony pentoxide, titanium dioxide, zirconium dioxide, manganese dioxide, cerium dioxide, copper oxide, zinc oxide, magnesium oxide, calcium oxide, molybdenum trioxide, etc., and furthermore, can also be combinations of two or more of the above metal oxides.

In this example, the thickness of the metal base 11 is 0.1 mm-1 mm, preferably 0.1 mm-0.8 mm, further preferably 0.1 mm-0.6 mm, further preferably 0.2 mm-0.6 mm, more preferably 0.2 mm-0.4 mm.

From the comparison with a quartz base applied in the prior art, in order to ensure the strength of the base, the thickness of the quartz base can only be 0.6 mm at the minimum, which is very difficult to realize. The metal base 11 is made of a metal material with good plasticity, and the thickness of the metal base 11 can be less than 0.6 mm, e.g., 0.2 mm, which further enhances product competitiveness.

In this example, the oxide film 12 may be formed on the surface of the metal base 11 by performing anodic oxidation or high-temperature aerobic oxidation.

The thickness of the oxide film 12 is 100 nm-1000 nm, preferably 100 nm-900 nm, further preferably 100 nm-800 nm, further preferably 100 nm-700 nm, further preferably 100 nm-600 nm, further preferably 100 nm-500 nm, further preferably 200 nm-500 nm, and most preferably 200 nm-400 nm.

The infrared emissivity of the oxide film 12 is at least 0.8, preferably 0.8-0.95, and more preferably 0.85-0.95.

The process of oxidation formation of the oxide film 12 on the inner surface of the metal base 11 is described below in connection with a specific preparation process:

### Embodiment 1-1

Select aluminum as a base material, and perform anodic oxidation on an inner surface of a metal base 11 to generate an oxide film 12.

Specifically, the flow of an anodic oxidation process is as follows:

(1) Degrease

At an operation temperature 50° C., put the metal base 11 into a degreasing tank, start timing, take out the metal base 11 after the time is up, and carry out a next step.

(2) Alkali wash

Employ a degreasing agent, at an operation temperature 50° C., put the metal base 11 into an alkaline washing tank for alkaline washing, and remove an oxide layer on the inner surface of the metal base 11, to expose the metal base.

(3) Acid wash

Employ nitric acid, at an operation temperature of normal temperature, put the metal base 11 into an acid pickling tank, and remove dirt on the inner surface of the metal base 11.

(4) Chemical polish

Employ phosphoric acid, at an operation temperature 92° C., put the metal base 11 into a chemical polishing tank, and rotate left and right to enable the inner surface of metal to be smoother, so as to reduce roughness.

(5) Anodic oxidation

Employ sulfuric acid, at an operation temperature 21° C., move the metal base 11 into an anode bath, and apply a voltage of 18 V to generate an oxide film aluminum oxide on the inner surface of the metal base 11.

(6) Hole seal

Employ a hole sealing agent, at an operation temperature 95° C., move the metal base 11 into a hole sealing groove, to improve abrasion resistance, corrosion resistance and electrical insulativity of the oxide film aluminum oxide.

(7) Dry

At an operation temperature 90° C., put the metal base 11 into a drying box, and dry moisture on the surface of the metal base 11.

### Embodiment 1-2

Still select aluminum as a base material, and perform high-temperature aerobic oxidation on an inner surface of a metal base 11 to generate an oxide film 12.

According to a high-temperature aerobic oxidation process, after-treatment is carried out on a metal workpiece, to generate an oxide film on a metal surface, and the oxide film has good chemical stability and few compact defects. The film has certain strength and plasticity, is firmly combined with the base, and has a small thermal expansion coefficient difference with the metal base.

Specifically, the flow of the high-temperature aerobic oxidation process is as follows:

(1) Degrease

At an operation temperature 50° C., put the metal base 11 into a degreasing tank, start timing, take out the metal base 11 after the time is up, and carry out a next step.

(2) Alkali wash

Employ a degreasing agent, at an operation temperature 50° C., put the metal base 11 into an alkaline washing tank for alkaline washing, and remove an oxide layer on the inner surface of the metal base 11, to expose the metal base.

(3) Acid wash

Employ nitric acid, at an operation temperature of normal temperature, put the metal base 11 into an acid pickling tank, and remove dirt on the inner surface of the metal base 11.

(4) Chemical polish

Employ phosphoric acid, at an operation temperature of 92° C., put the metal base 11 into a chemical polishing tank, and rotate left and right to enable the inner surface of metal to be smoother, so as to reduce roughness.

(5) High-temperature aerobic oxidation

Perform high-temperature aerobic oxidation in an atmosphere furnace at an oxidation temperature of 440° C. for 48 hours under an oxygenation pressure of 0.7 MPa to generate a compact oxide film on the inner surface of the metal base 11.

A heating body 13 is provided on the outer surface of the metal base 11. The heating body 13 is configured to receive electric power from a power supply to generate heat, and transfer the heat to the oxide film 12 such that the oxide film 12 is heated by the heat and the temperature thereof rises to generate infrared rays.

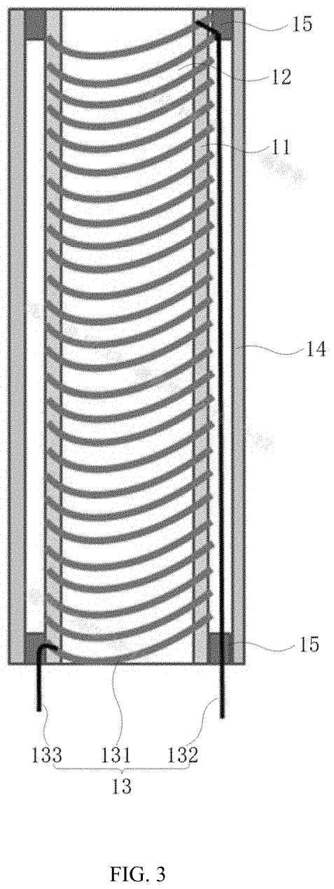

Please refer to FIG. 3. In one example, the heating body 13 includes a resistive heating layer 131 formed the an outer surface of the metal base 11, a first electrode 132 and a second electrode 133 electrically connected to the resistive heating layer 131. The first electrode 132 and the second electrode 133 are configured to feed the electric power from the power supply to the resistive heating layer 131.

In this example, the resistive heating layer 131 is a resistive heating tape spirally around the surface of the metal base 11, the resistive heating tape extending with equal pitch along the longitudinal direction of the metal base 11. The resistive heating tape with the equal pitch can enable the oxide film 12 to be heated uniformly, ensuring the heating speed, the fragrance volatilization uniformity and the smoking taste of the aerosol generation substrate.

The resistive heating layer 131 may be made of metal materials, carbon materials, semiconductor materials, or the like. Specifically, conductive metal materials include: aluminum, copper, titanium, chromium, silver, iron, nickel, and the like; alloy components of the above metal such as stainless steel, iron-chromium-aluminum alloy, nickel-chromium alloy, nickel-iron alloy and the like;

carbon materials include: graphite, conductive diamond-like carbon, carbon fibers, carbon nanotubes, graphene, and the like; and

semiconductor materials include: indium tin oxide, nickel oxide, silicon carbide, aluminum nitride, gallium nitride, doped tin oxide, zinc oxide, and doped zinc oxide, such as AZO, GZO, IZO, doped B, doped N, P, As, Sb, Mo, doped La elements, doped IA(Li, Na, K), doped IB(Au, Ag, Cu) elements and the like.

According to heating temperature and power requirements, a proper resistive heating layer 131 material is selected to form a resistive film with a proper thickness, and obtain a proper resistance range, where the resistance value of the resistive heating layer 131 may be 0.1 ohm-10 ohm, preferably 0.3 ohm-8 ohm, further preferably 0.5 ohm-5 ohm, and more preferably 0.6 ohm-3.5 ohm.

In this example, the resistive heating layer 131 is deposited on the oxide film 12 by a physical vapor deposition method. The formation of the resistive heating layer 131 on the oxide film 12 will be described below in connection with a specific preparation process:

### Embodiment 2-1

A direct-current power supply, a direct-current pulse power supply or a medium-frequency power supply is employed for deposition. The preparation process is as follows:

Employ a titanium target and a direct-current power supply, and deposit a titanium metal film on an outer surface of a metal base 11, where titanium is relatively good in stability, good in biocompatibility, safe in food-grade contact, relatively high in resistivity (relative to silver, copper and the like), and relatively good in film resistance control.

Due to the fact that the resistivity of titanium is relatively high (5.56*10⁻⁷ ohm·m), when titanium is welded or connected to electrodes, the electrodes and the titanium metal film are in point contact, which will lead to relatively high contact resistance. Therefore, a silver film with low resistivity (1.62*10⁻⁶ ohm·m) needs to be deposited to reduce the contact resistance.

Take out the metal base 11 plated with the titanium metal film, partially cover the metal base 11 with metal or a high-temperature-resistant film material to reserve places where contact electrodes need to be plated, put the metal base into a vacuum chamber, and vacuumize to be below 5*10⁻⁴ Pa.

Power on a direct-current power supply of a silver target, to deposit a silver film in a region covered by the metal base 11, the resistance of the titanium metal film plated with the silver film being 1-3 ohms, preferably 2 ohms.

After plating of the silver film is completed, take out the metal base 11, uncover the metal film or the high-temperature-resistant film for covering, and thus complete preparation of the resistive heating layer 131 and the electrodes (132, 133).

Furthermore, the heater 1 further includes an infrared reflecting layer which is a flexible layer and may be aluminum foil. Preferably, an infrared reflecting material such as metal is deposited on a flexible base material 14 by a physical vapor deposition method, and the flexible base material 14 is wrapped on the periphery of the resistive heating layer 131 to reflect infrared rays radiated to the outer side of the metal base 11 back to the resistive heating layer 131. The flexible base material 14 may be made of a material having high infrared reflectivity, such as polyether-ether-ketone or polyimide.

Spacers 15 are further provided between the flexible base material 14 and the resistive heating layer 131, and a gap is formed between the infrared reflecting layer and the resistive heating layer 131 by the spacers 15, to reduce the loss of heat to the direction away from the aerosol generation substrate. The spacer 15 may be in the form of a block, protrusion, or another shape, and the number and shape of the spacer is not limited herein. The spacer 15 is made of at least one of polyether-ether-ketone, zirconia ceramic, and alumina ceramic.

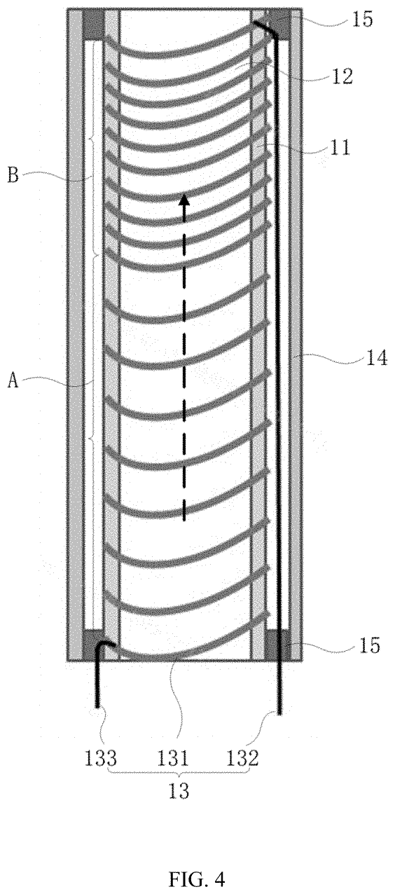

Referring to FIG. 4, unlike the example of FIG. 3, a resistive heating tape 131 in a spiral shape extends with varying pitches along the longitudinal direction of the metal base 11, to distribute heat supplied to the oxide film 12 as desired. It is worth noting that extending along the longitudinal direction of the metal base 11 means wholly or substantially extending along that direction, e.g., as shown by a spiral line in FIG. 3 or FIG. 4. The outer surface of the metal base 11 has a first region A and a second region B, the first region A is close to the upstream of an aerosol moving path (a dashed arrow in the figures), and the second region B is close to the downstream of the aerosol moving path. The pitch of the resistive heating tape located in the first region A is greater than the pitch of the resistive heating tape located in the second region B.

By configuring different pitches of the resistive heating tapes in different regions of the metal base 11, the heating speed of the aerosol generation substrate in the downstream region can be increased, the effect of rapid smoke emission can be achieved, and the user experience can be improved.

It should be noted that, FIG. 3 and FIG. 4 only show the spiral resistive heating tape, and the resistive heating layer 131 may be other patterned conductive tracks.

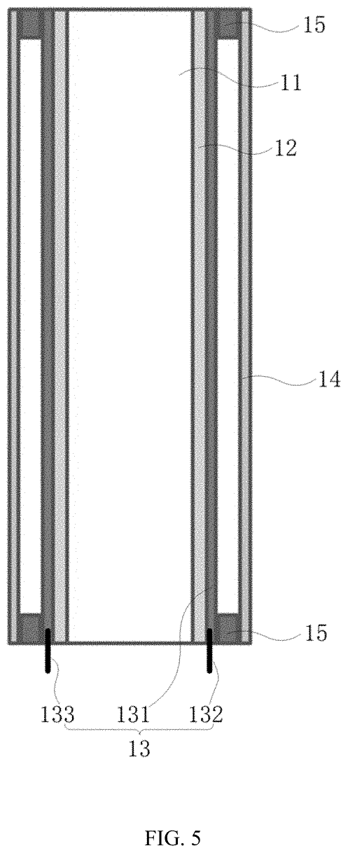

Refer to FIG. 5, which differs from the examples shown in FIG. 3 and FIG. 4 in that the resistive heating layer 131 is a continuous conductive film wrapped on the outer surface of the metal base 11, that is, the resistive heating layer 131 is wrapped on the entire outer surface of the metal base 11.

It should be noted that it is also feasible that the resistive heating layer 131 covers a part of the surface of the metal base 11.

In this example, the resistance value of the resistive heating layer 131 may be 0.5 ohms to 3 ohms, and the deposition thickness is 0.3 micrometers to 3 micrometers.

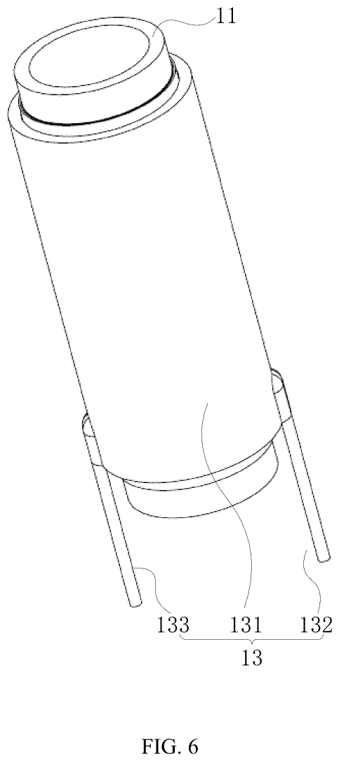

Referring to FIG. 6, in another example, the heating body 13 includes a heating element 131 separable from the metal base 11, and electrodes (132, 133) electrically connected to the heating element 131. The electrodes (132, 133) are configured to feed electric power from the power supply to the heating element 131.

In this example, the heating element includes but is not limited to a ceramic heating element sleeved on the outer surface of the metal base 11, a metal heating element sleeved on the outer surface of the metal base 11, a heating wire wound on the outer surface of the metal base 11, a flexible printed circuit (FPC) heating film wrapped on the outer surface of the metal base 11, and the like.

### Second Embodiment

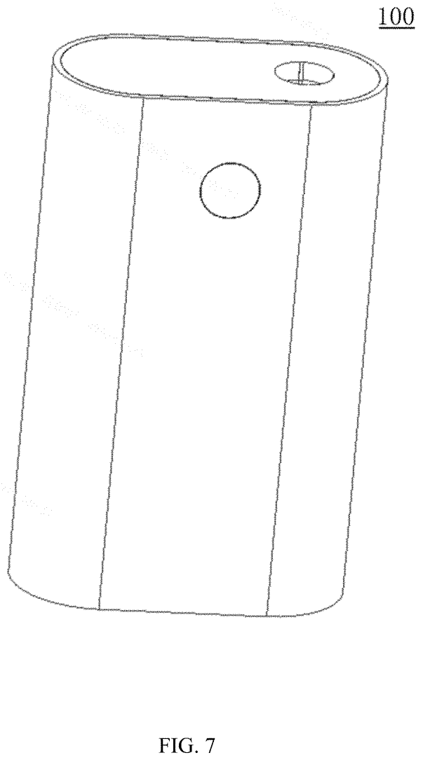

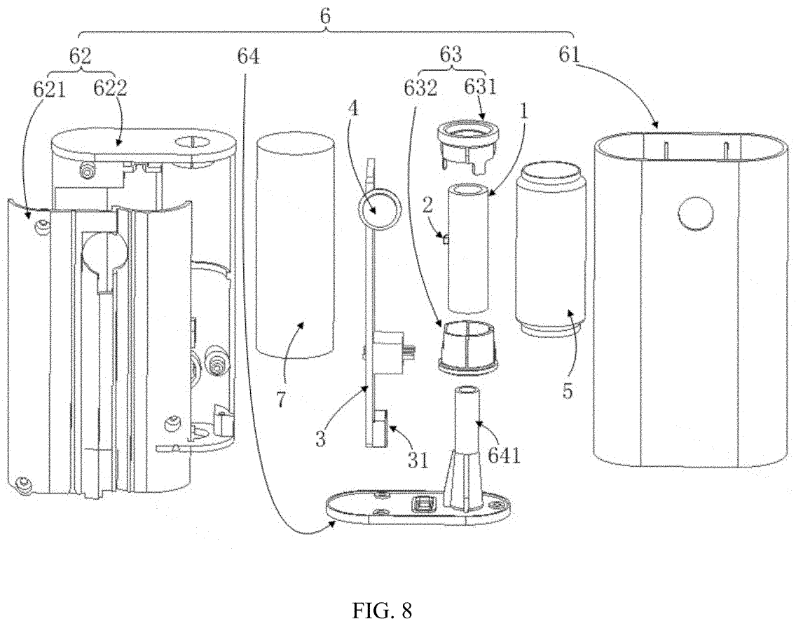

FIG. 7 and FIG. 8 show a smoking set 100 according to a second embodiment of the present application, including a housing assembly 6, and the heater 1 according to the first embodiment, the heater 1 being provided within the housing assembly 6. According to the smoking set 100 provided by the present embodiment, by using an oxide film 12 formed by oxidation on an inner surface of a metal base 11, a resistive heating layer 131 deposited on an outer surface of the metal base 11 by a physical vapor deposition method, and electrodes (132, 133) electrically connected to the resistive heating layer 131, the resistive heating layer 131 generates heat by using electric power from a battery 7 received by the electrodes (132, 133), such that the oxide film 12 is heated by the heat and generate infrared rays, and the oxide film 12 radiatively heats an aerosol generation substrate within a cavity of the metal base 11.

The housing assembly 6 includes a housing 61, a fixed housing 62, a fixed piece 63 and a bottom cover 64, both the fixed housing 62 and the fixed piece 63 being fixed within the housing 61, where the fixed piece 63 is configured to fix the metal base 11, the fixed piece 63 is provided within the fixed housing 62, and the bottom cover 64 is provided at one end of the housing 61 and covers the housing 61. Specifically, the fixed piece 63 includes an upper fixed seat 631 and a lower fixed seat 632, both the upper fixed seat 631 and the lower fixed seat 632 being provided within the fixed housing 62. A first end and a second end of the metal base 11 are respectively fixed to the upper fixed seat 631 and the lower fixed seat 632. An air inlet pipe 641 is provided on the bottom cover 64 in a protruding manner. The air inlet pipe 641 is connected to the end, away from the upper fixed seat 631, of the lower fixed seat 632. The upper fixed seat 631, the metal base 11, the lower fixed seat 632 and the air inlet pipe 641 are coaxially provided. The space between the metal base 11 and the upper fixed seat 631 as well as the space between the metal base 11 and the lower fixed seat 632 are sealed. The lower fixed seat 632 is also sealed with the air inlet pipe 641. The air inlet pipe 641 is in communication with outside air, such that air intake can be smooth when a user smokes.

The smoking set 100 further includes a main control circuit board 3 and a battery 7. The fixed housing 62 includes a front housing 621 and a rear housing 622. The front housing 621 is fixedly connected to the rear housing 622. Both the main control circuit board 3 and the battery 7 are provided within the fixed housing 62. The battery 7 is electrically connected to the main control circuit board 3. A key 4 is provided on the housing 61 in a protruding manner. By pressing the key 4, the resistive heating layer 131 on the outer surface of the metal base 11 can be powered on or powered off. The main control circuit board 3 is further connected to a charging interface 31. The charging interface 31 is exposed on the bottom cover 64. The user can charge or upgrade the smoking set 100 by using the charging interface 31, to ensure continuous use of the smoking set 100.

The smoking set 100 further includes an insulating pipe 5. The insulating pipe 5 is provided within the fixed housing 62. The insulating pipe 5 is sleeved outside the metal base 11. The insulating pipe 5 can prevent a large amount of heat from being transferred to the outer housing 61 and causing the user to feel hot. The insulating pipe includes a heat insulating material. The heat insulating material may be heat insulating glue, aerogel, aerogel felt, asbestos, aluminum silicate, calcium silicate, diatomite, zirconium oxide and the like. The insulating pipe 5 may further include a vacuum insulating pipe. The interior of the insulating pipe 5 may also be coated with an infrared reflective coating, so as to reflect infrared rays emitted by the oxide film 12 back to the resistive heating layer 131 to improve heating efficiency.

The smoking set 100 further includes a temperature sensor, such as an NTC temperature sensor 2, for detecting a real-time temperature of the metal base 11, and transmitting the detected real-time temperature to the main control circuit board 3, and the main control circuit board 3 adjusts the magnitude of a current flowing through the resistive heating layer according to the real-time temperature. Specifically, when the NTC temperature sensor 2 detects that the real-time temperature within the metal base 11 is low, e.g., when the temperature within the metal base 11 is detected to be less than 150° C., the main control circuit board 3 controls the battery 7 to output a higher voltage to the electrodes (132, 133), thereby increasing the current fed to the resistive heating layer 131, increasing the heating power of the aerosol generation substrate, and reducing a waiting time for the user to start smoking. When the NTC temperature sensor 2 detects that the temperature of the metal base 11 is 150° C.-200° C., the main control circuit board 3 controls the battery 7 to output a normal voltage to the electrodes (132, 133). When the NTC temperature sensor 2 detects that the temperature of the metal base 11 is 200° C.-250° C., the main control circuit board 3 controls the battery 7 to output a lower voltage to the electrodes (132, 133). When the NTC temperature sensor 2 detects that the temperature within the metal base 11 is 250° C. and above, the main control circuit board 3 controls the battery 7 to stop outputting the voltage to the electrodes (132, 133).

It should be noted that preferred embodiments of the present application are given in the specification and accompanying drawings thereof, but the present application can be embodied in many different forms and is not limited to the embodiments described in the specification, and these embodiments are not intended as additional limitations on the present application. These embodiments are provided for the purpose of achieving a more thorough and complete understanding of the disclosure of the present application. Furthermore, the above technical features continue to be combined with each other to form various embodiments not listed above, all of which are considered to be within the scope of the specification of the present application. Furthermore, it will be apparent to those of ordinary skill in the art that modifications or variations may be made in light of the above description, and all such modifications and variations should fall within the scope of the appended claims.

1. A heater, wherein the heater is configured to heat an aerosol generation substrate to volatilize at least one component in the aerosol generation substrate, and the heater comprises:
a metal base, having an inner surface and an outer surface;
an oxide film, formed by oxidization on the inner surface of the metal base, the oxide film being configured to generate infrared rays and at least radiatively heat the aerosol generation substrate; and
a heating body, provided on the outer surface of the metal base, the heating body being configured to receive electric power from a power supply to generate heat, and transfer the heat to the oxide film such that the oxide film is heated by the heat and the temperature thereof rises, to generate infrared rays.

2. The heater according to claim 1, wherein the oxide film is formed on the inner surface of the metal base by performing anodic oxidation or high-temperature aerobic oxidation.

3. The heater according to claim 1, wherein the thickness of the oxide film is 100 nm-1000 nm, preferably 100 nm-900 nm, further preferably 100 nm-800 nm, further preferably 100 nm-700 nm, further preferably 100 nm-600 nm, further preferably 100 nm-500 nm, further preferably 200 nm-500 nm, and most preferably 200 nm-400 nm.

4. The heater according to claim 1, wherein the infrared emissivity of the oxide film is at least 0.8, preferably 0.8-0.95, and more preferably 0.85-0.95.

5. The heater according to claim 1, wherein the metal base is made of at least one of the following materials:
titanium, aluminum, zirconium, nickel, zinc, magnesium, tin, iron, chromium, indium, lanthanum, cobalt, antimony, manganese, cerium, copper, calcium, molybdenum, and alloys thereof.

6. The heater according to claim 1, wherein the thickness of the metal base is 0.1 mm-1 mm, preferably 0.1 mm-0.8 mm, further preferably 0.1 mm-0.6 mm, further preferably 0.2 mm-0.6 mm, more preferably 0.2 mm-0.4 mm.

7. The heater according to claim 1, wherein the heating body comprises a resistive heating layer formed on the outer surface of the metal base, and electrodes electrically connected to the resistive heating layer; and the electrodes are configured to feed electric power from the power supply to the resistive heating layer.

8. The heater according to claim 7, wherein the resistive heating layer is a patterned conductive track formed on the outer surface of the metal base.

9. The heater according to claim 8, wherein the patterned conductive track is a spiral resistive heating tape, and the resistive heating tape spirally extends along the longitudinal direction of the metal base.

10. The heater according to claim 9, wherein the resistive heating tape extends with equal pitch along the longitudinal direction of the metal base.

11. The heater according to claim 9, wherein the resistive heating tape extends with varying pitches along the longitudinal direction of the metal base, to distribute heat supplied to the oxide film as desired.

12. The heater according to claim 7, wherein the resistive heating layer is a continuous conductive film wrapped on the outer surface of the metal base.

13. The heater according to claim 7, wherein the resistance value of the resistive heating layer is 0.1 ohm-10 ohm, preferably 0.3 ohm-8 ohm, further preferably 0.5 ohm-5 ohm, and more preferably 0.6 ohm-3.5 ohm.

14. The heater according to claim 13, wherein the resistive heating layer comprises at least one of metal materials, carbon materials, and semiconductor materials.

15. The heater according to claim 14, wherein the resistive heating layer is deposited on the outer surface of the metal base by a physical vapor deposition method.

16. The heater according to claim 1, wherein the heating body comprises a heating element separable from the metal base, and electrodes electrically connected to the heating element; and the electrodes are configured to feed the electric power from the power supply to the heating element.

17. The heater according to claim 16, wherein the heating element comprises at least one of the following:
a ceramic heating element sleeved on the outer surface of the metal base;
a metal heating element sleeved on the outer surface of the metal base;
a heating wire wound on the outer surface of the metal base; and
a flexible printed circuit (FPC) heating film wrapped on the outer surface of the metal base.

18. A smoking set, comprising:
a housing assembly; and
the heater according to claim 1, the heater being provided within the housing assembly.

19. The smoking set according to claim 18, wherein the heater further comprises a hollow insulating pipe; and
the insulating pipe is provided on the periphery of the heater, configured to at least partially prevent heat from being transferred to the housing assembly from the heater.
